(19) United States
(12) Patent Application Publication
(10) Pub. No.: US 2014/0097261 A1
(43) Pub. Date: Apr. 10, 2014

(54) HEAT TRANSPORTING ARRANGEMENT AND METHOD FOR THE EXCHANGE OF HEAT IN A MOTOR VEHICLE BY MEANS OF THE HEAT TRANSPORTING ARRANGEMENT

(71) Applicant: Robert Bosch GmbH, Stuttgart (DE)

(72) Inventors: Andreas Blumenstock, Ludwigsburg (DE); Joerg Heyse, Besigheim (DE); Thomas Demmer, Stuttgart (DE)

(21) Appl. No.: 14/047,094

(22) Filed: Oct. 7, 2013

(30) Foreign Application Priority Data
Oct. 5, 2012 (DE) 10 2012 218 191.1

(51) Int. Cl. B60H 1/00; F01N 5/02; B60H 1/22

(52) U.S. Cl. CPC B60H 1/00492; B60H 1/22; F01N 5/02
USPC 237/5; 237/44; 60/320; 165/41

(57) ABSTRACT

A heat transporting arrangement (10) for a motor vehicle, having at least one heat circuit (14, 16, 50) in which a heat transporting medium is accommodated and which is thermally coupled to one of the components of a drivetrain in order to exchange heat between the component and the heat transporting medium, a temperature control device (25) which is configured to heat a passenger compartment of a motor vehicle, and a heat store arrangement (30) which is coupled to the heat circuit (14, 16, 50) and to the temperature control device (25) and which is configured to store heat discharged from the heat transporting medium and to release said heat for of heating one of the components of the drivetrain and the passenger compartment.

### BACKGROUND OF THE INVENTION

The present invention relates to a heat transporting arrangement for a motor vehicle, wherein the motor vehicle has a drivetrain with a multiplicity of components and wherein one of the components is an internal combustion engine.

The present invention also relates to a method for the exchange of heat in a motor vehicle by means of a heat transporting arrangement, wherein the motor vehicle has a drivetrain with a multiplicity of components, and wherein one of the components is an internal combustion engine.

In the field of automotive drive technology, it is generally known to use an internal combustion engine as a sole drive or together with a drive motor of some other type (hybrid drive). In the case of a hybrid drive, use is typically made of an electric induction machine as an additional drive motor of a motor vehicle. Here, the electric induction machine is supplied with electrical energy by a (high-voltage) battery situated on board the motor vehicle.

Furthermore, it is known for the drive and in particular the internal combustion engine to be cooled by means of a coolant. The waste heat gained from this is supplied to a heating heat exchanger in order to heat a passenger compartment of the motor vehicle. The heating power for the passenger compartment is thus provided primarily from the internal combustion engine.

If the internal combustion engine is started after the motor vehicle has been at a standstill for a relatively long time, then during the so-called cold start and in the subsequent warm-up phase of the internal combustion engine, a very large amount of energy is consumed because, for example, the engine oil is still cold and the internal combustion engine accordingly exhibits increased friction. Furthermore, high levels of emissions are generated because, owing to the initially cold engine exhaust gases, the catalytic converter connected downstream of the internal combustion engine has not yet warmed up to operating temperature, and therefore allows all of the untreated emissions of the internal combustion engine to pass into the environment. For this reason, it is expedient to shorten the warm-up phase of the engine in order to eliminate or minimize the above-stated disadvantages.

For this purpose, in known systems, a latent heat store is provided in an engine oil circuit of the motor vehicle, wherein the engine oil circuit is thermally coupled to the internal combustion engine. During the operation of the internal combustion engine, the latent heat store is charged with the waste heat of the internal combustion engine. The stored heat is released into the internal combustion engine before or during the cold start and during the warm-up of the internal combustion engine in order to reduce its friction losses and exhaust-gas emissions. Thus, the heat transfer between the internal combustion engine and the latent heat store takes place by means of the engine oil circuit.

With regard also to the climate control in the passenger compartment of the motor vehicle, a corresponding storage of waste heat from the drive would be desirable, thus permitting climate control of the passenger compartment even when the internal combustion engine is in a shut-down state. This is important in particular against the background that, in motor vehicles, there are numerous operating phases in which the internal combustion engine is shut down in order to minimize energy consumption. For example, conventional vehicles are equipped with an automatic start-stop facility which shuts the internal combustion engine down when the motor vehicle is at a standstill or travelling at low speeds. Likewise, hybrid vehicles may be driven purely electrically for a certain period of time (that is to say, in said operating phase, the internal combustion engine is shut down).

However, if the internal combustion engine is in a shut-down state, there is no hot cooling water, or only an insufficient amount of hot cooling water, available for the heating of the passenger compartment.

Systems are known from the prior art which provide storage of thermal energy in a thermal store designed for the climate control of the passenger compartment, in order thereby to cool the vehicle passenger compartment when the internal combustion engine is in a shut-down state.

A disadvantage of the known systems is that different concepts and separately formed systems are used for the pre-heating of the engine and the climate control of the passenger compartment. The stored heat thus cannot be utilized effectively for the pre-heating of the engine and climate control of the passenger compartment. Furthermore, the separate systems result in higher costs.

### SUMMARY OF THE INVENTION

The present invention therefore provides a heat transporting arrangement for a motor vehicle, wherein the motor vehicle has a drivetrain with a multiplicity of components and wherein one of the components is an internal combustion engine, wherein the heat transporting arrangement has at least one heat circuit in which a heat transporting medium is accommodated and which is thermally coupled to one of the components of the drivetrain in order to exchange heat between the component and the heat transporting medium, a temperature control device which is designed to heat a passenger compartment of the motor vehicle, and a heat transporting arrangement which is coupled to the heat circuit and to the temperature control device and which is designed to store heat discharged from the heat transporting medium and to release said heat for the purpose of heating one of the components of the drivetrain and the passenger compartment.

Furthermore, the present invention provides a method for the exchange of heat in a motor vehicle by means of a heat transporting arrangement, wherein the motor vehicle has a drivetrain with a multiplicity of components, wherein one of the components is an internal combustion engine, wherein the heat transporting arrangement has at least one heat circuit, which is thermally coupled to one of the components of the drivetrain, a temperature control device and a heat transporting arrangement which is coupled to the heat circuit and to the temperature control device, wherein according to the method, heat is discharged from one of the components of the drivetrain by means of the heat circuit, wherein the heat from the heat circuit is stored in the heat transporting arrangement, and wherein the stored heat is released from the heat transporting arrangement to the heat circuit in order to heat one of the components of the drivetrain and a passenger compartment of the motor vehicle.

By means of the present invention, use is made of a combined system having a heat transporting arrangement which can be used both for the pre-heating of the drivetrain and also for the climate control of the passenger compartment. By means of the heat transporting arrangement, the waste heat generated by the drivetrain can be stored by means of different heat circuits in the heat transporting arrangement. For this purpose, the heat circuits are or can be thermally coupled to different components of the drivetrain. Said stored heat may for example be released before or during a cold start, and the subsequent warm-up phase of the internal combustion engine, for the purpose of pre-heating the engine and heating the passenger compartment. Analogously, the stored heat may also be used during purely electric driving operation of a hybrid vehicle for the purpose of keeping the internal combustion engine and the passenger compartment warm. The distribution of the heat is in this case adapted flexibly to the requirements for the pre-heating of the drivetrain and the pre-heating of the passenger compartment. The heat transporting arrangement thus constitutes a local interconnection point in terms of heat transfer technology for all heat circuits which are thermally coupled to the heat transporting arrangement. The waste heat of the drivetrain can thus be utilized in a highly energy-efficient manner.

The heat transporting arrangement according to the invention can be realized in an inexpensive manner because a uniform concept or a uniform system is used for the pre-heating of the drivetrain and the heating of the passenger compartment.

In a particularly preferred embodiment, the temperature control device is designed to cool one of the components of the drivetrain and/or the passenger compartment and the heat transporting arrangement is designed to release the stored heat for the purpose of cooling one of the components of the drivetrain and/or the passenger compartment.

Thus, in this embodiment, the passenger compartment of the motor vehicle can be either heated or cooled according to demand. Furthermore, by means of the temperature control device, it is also possible for drivetrain components that are subject to particularly high thermal loading to be cooled. For example, it is possible in the case of a hybrid vehicle to cool a fraction battery and/or an electric machine which is used for driving the hybrid vehicle. Furthermore, in this embodiment, the heat transporting arrangement is capable of storing thermal energy and providing said thermal energy for later cooling of the vehicle passenger compartment and/or of drivetrain components. This is advantageous in particular in situations in which the internal combustion engine is in a shut-down state. For example, the vehicle passenger compartment can continue to be cooled even during purely electric driving operation of a hybrid vehicle.

In a further embodiment, the heat circuit is a cooling water circuit in which cooling water is accommodated as a heat transporting medium and which is or can be thermally coupled to the internal combustion engine in order to heat or cool the internal combustion engine by means of the cooling water.

By means of the cooling water circuit, the excess heat of the internal combustion engine can be dissipated and stored in the heat transporting arrangement. The heat stored in the heat transporting arrangement is available for later pre-heating of the internal combustion engine for example in the event of a cold start. It is thus possible for the energy consumption and discharge of emissions to be reduced. Further drivetrain components to be cooled may also be integrated into the cooling water circuit. For example, the cooling water circuit may be utilized for cooling an electric drive (hybrid vehicle) or for cooling charge air.

In accordance with a further embodiment, the temperature control device has a heat exchanger which is thermally coupled to the cooling water circuit and which is designed to transfer heat from the heat transporting medium into the passenger compartment of the motor vehicle.

By means of the heat exchanger and, for example, an associated heating fan, the heat of the heat transporting medium is transferred into the passenger compartment. Here, it is possible for the vehicle passenger compartment to be heated both while the internal combustion engine is running and also when the internal combustion engine is in a shut-down state, because the waste heat of the drivetrain is stored in the heat transporting arrangement and is made available from the latter again as required.

In a further embodiment, the heat circuit is an engine oil circuit in which engine oil is accommodated as a heat transporting medium and which is or can be thermally coupled to the internal combustion engine in order to heat or cool the internal combustion engine by means of the engine oil.

The waste heat of the internal combustion engine is discharged by means of the engine oil circuit and is stored in the heat transporting arrangement as required. Furthermore, using the heat stored in the heat transporting arrangement, the engine oil circuit can be utilized for highly effective pre-heating of the internal combustion engine before or during a cold start.

In a further embodiment, one of the components of the drivetrain is a transmission, and the heat circuit is a transmission oil circuit in which transmission oil is accommodated as a heat transporting medium and which is or can be thermally coupled to the transmission in order to heat or cool the transmission by means of the transmission oil.

By means of this measure, the excess heat of the transmission is dissipated, and thus the transmission is cooled and protected against thermal damage. By means of the heat transporting arrangement and the transmission oil circuit, the transmission can be pre-heated for example during a cold start. In this way, the friction losses of the transmission are minimized, and thus the energy consumption of the motor vehicle is reduced.

In accordance with a further embodiment, the heat circuit is an exhaust-gas heat circuit in which an exhaust-gas heat transporting medium is accommodated as a heat transporting medium and which is or can be thermally coupled via an exhaust-gas heat exchanger to an exhaust-gas stream of the internal combustion engine in order to transfer heat of the exhaust-gas stream to the exhaust-gas heat transporting medium.

As a result of the use of the exhaust-gas heat in the heat transporting arrangement, the waste heat of the drivetrain is utilized in a highly energy-efficient manner. In this embodiment, the heat discharged from the exhaust-gas stream is stored in the heat transporting arrangement. Said thermal energy is thus available for subsequent heating/cooling of the passenger compartment and/or of drivetrain components.

It is particularly preferable if the heat transporting arrangement has a multiplicity of heat circuits which are in each case thermally coupled to one of the components of the drivetrain, wherein the heat transporting arrangement is thermally coupled to each of the heat circuits.

In this embodiment, the heat circuits may be coupled in each case to different components of the drivetrain. Alternatively, a subset of the heat circuits may also be coupled to the same component of the drivetrain. Furthermore, the heat transporting arrangement constitutes a local interconnection point in terms of heat transfer technology for all heat circuits which flow through the heat transporting arrangement. In other words, the heat from different heat circuits is stored in the heat transporting arrangement and can, at a later time, be distributed again individually to the different heat circuits according to requirements.

In accordance with a further embodiment, one of the heat circuits is the cooling water circuit and another of the heat circuits is the engine oil circuit.

By means of said two heat circuits, the waste heat of the internal combustion engine can be dissipated, and stored in the heat transporting arrangement, in a highly effective manner. The stored heat may for example be utilized, via the engine oil circuit and the cooling water circuit, for pre-heating the internal combustion engine. Furthermore, in this embodiment, it is possible for the passenger compartment of the motor vehicle to be heated by means of the cooling water circuit even when the internal combustion engine is in a shut-down state.

In a further embodiment, the heat transporting arrangement has a latent heat store.

Latent heat stores are heat stores in which a storage medium absorbs heat energy or releases heat energy while undergoing a change of state (for example a change in the state of aggregation). Here, the thermal energy can be stored in the latent heat store with low losses, over many repeat cycles and over a long period of time.

In one embodiment, the latent heat store may be arranged such that the thermal contact with the cooling water circuit is realized a short distance upstream of the point at which the cooling water flows through the heat exchanger. Thus, the heat of the cooling water circuit is utilized in a highly effective manner for the heating of the passenger compartment by means of the heat exchanger. Heat losses within the cooling water circuit are substantially eliminated.

In a further embodiment, the latent heat store may be arranged such that it is in direct thermal contact/mechanical contact with the heat exchanger.

It is thus possible, with the use of a heating fan, for the latent heat store to transfer its thermal energy directly to the heat exchanger, without the cooling water circuit having to be used for this purpose. It is thus possible for the number of heat circuits that are conducted through the latent heat store to be reduced. The construction of the latent heat store is simplified in this way.

In a further embodiment, the heat transporting arrangement has components of the heat circuits (for example pumps, valves and/or fluid lines).

As a result of the integration of system components in the vicinity of the store into the heat transporting arrangement, the assembly outlay for the heat transporting arrangement is reduced.

In a further embodiment, the heat transporting arrangement has an adsorption store and the temperature control device has a condenser and an evaporator, wherein the condenser is designed to condense the adsorbate released during a desorption phase of the adsorption store, and wherein the evaporator is designed to evaporate the condensed adsorbate, to cool a medium surrounding the evaporator and to supply the adsorbate to the adsorption store during an adsorption phase of the adsorption store.

An adsorption is to be understood to mean an enrichment of substances composed of gases or liquids on the surface of a solid body (more generally on the boundary surface between two phases). By contrast, a desorption refers to a process in which atoms or molecules depart from the surface of a solid body. Said processes are used, in the present embodiment, for storage and release of thermal energy.

Through the use of an adsorption store and the temperature control device connected thereto, the vehicle passenger compartment and/or drivetrain components can be cooled or heated. It is thus possible, for example, for the passenger compartment to continue to be cooled during purely electric driving operation of a hybrid vehicle (that is to say when an internal combustion engine is in a shut-down state).

In a particularly preferred embodiment of the method, the stored heat is released from the heat transporting arrangement in order to cool one of the components of the drivetrain and/or the passenger compartment.

It is thus possible, for example, for a traction battery of a hybrid vehicle to be cooled during purely electric driving operation. Damage to the traction battery as a result of overheating is thus prevented. Furthermore, driving comfort is increased because the vehicle passenger compartment is cooled even while an internal combustion engine is in a shut-down state.

In a further embodiment of the method, at least a part of the heat is discharged and stored while the internal combustion engine is in a shut-down state.

Increasing numbers of motor vehicles are being equipped with a so-called automatic start-stop facility. The automatic start-stop facility has the effect that the internal combustion engine is shut down for example when the vehicle comes to a standstill at a traffic signal. Since the drivetrain still exhibits sufficient waste heat in this state, said excess thermal energy can be stored in the heat transporting arrangement. This applies analogously for example to a switch from internal-combustion-engine-powered driving operation to purely electric driving operation in a hybrid vehicle.

In accordance with a further embodiment of the method, at least a part of the stored heat is released while the internal combustion engine is in a shut-down state.

In the above-mentioned example of the vehicle coming to a standstill at a traffic signal, it is thus possible for the vehicle passenger compartment to continue to be cooled or heated even while an internal combustion engine is in a shut-down state. Furthermore, the internal combustion engine can be pre-heated before a cold start in order to reduce the energy consumption and the discharge of emissions during the subsequent warm-up phase of the internal combustion engine.

### BRIEF DESCRIPTION OF THE DRAWINGS

FIGS. 1 to 7 show, in schematic form, different embodiments of a heat transporting arrangement for a motor vehicle; and

FIG. 8 shows a diagram for the explanation of an embodiment of a method according to the invention.

### DETAILED DESCRIPTION

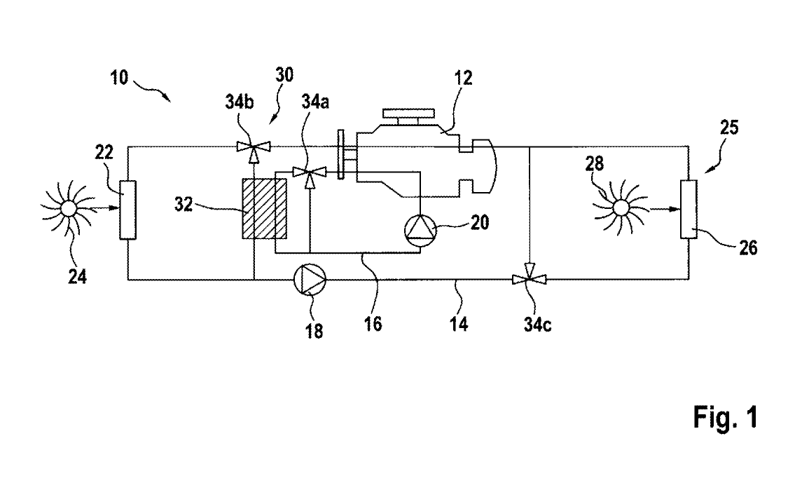

FIG. 1 shows a heat transporting arrangement 10 for a motor vehicle which is not shown in any more detail in FIG. 1. The motor vehicle has a drivetrain with a multiplicity of components, wherein one of the components is an internal combustion engine 12. The drivetrain may additionally have an electric machine for driving the motor vehicle and a traction battery which provides electrical energy for the electric machine. A motor vehicle having a drivetrain of said type is referred to as a hybrid vehicle.

The heat transporting arrangement 10 has two heat circuits, specifically a cooling water circuit 14 and an engine oil circuit 16, which are both thermally coupled to the internal combustion engine 12 for the purpose of exchanging heat between the internal combustion engine 12 and the heat circuits. In the cooling water circuit 14 there is accommodated cooling water which is circulated in the cooling water circuit 14 by a pump 18. Analogously, engine oil is accommodated in the engine oil circuit 16, said engine oil being circulated in the engine oil circuit 16 by a pump 20.

Furthermore, in the cooling water circuit 14, there is integrated a front-end radiator 22 around which a relative wind flows and which thus cools the cooling water flowing through it. The cooling of the cooling water is assisted by an engine fan 24 which is arranged in the direct vicinity of the front-end radiator 22. Furthermore, the cooling water circuit 14 has a temperature control device 25 with a heat exchanger 26 which serves, in combination with a heating fan 28, for heating of a passenger compartment of the motor vehicle.

Furthermore, the heat transporting arrangement 10 has a heat transporting arrangement 30 with a latent heat store 32. Latent heat stores are capable of storing thermal energy with low losses, over many repeat cycles and over a long period of time. For this purpose, use is made of so-called phase change materials (PCM) whose latent heat of fusion, heat of solution or heat of adsorption is significantly higher than the heat that it can store based on its normal specific heat capacity. The latent heat store 32 may be designed such that the latent heat store 32 is coated with the phase change material or such that the phase change material is encapsulated in the latent heat store 32 (in cavities separated from the cooling water), wherein the phase change material is melted in order to store heat and releases heat as it solidifies.

In this exemplary embodiment, the cooling water circuit 14 and the engine oil circuit 16 are led through the latent heat store 32 and thus thermally coupled to the latter. The latent heat store 32 thus constitutes a local interconnection point in terms of heat transfer technology for the cooling water circuit 14 and the engine oil circuit 16.

In an alternative embodiment, instead of the common latent heat store 32, use is made of multiple latent heat stores which are coupled to one another in terms of heat, said latent heat stores being thermally coupled in each case to one of the heat circuits. In this embodiment, too, the latent heat stores that are coupled to one another in terms of heat constitute an interconnection point in terms of heat transfer technology for the heat circuits involved.

When the internal combustion engine 12 is running, it generates waste heat which is dissipated by the cooling water circuit 14 and by the engine oil circuit 16. By means of bypass valves 34 of the cooling water circuit 14 and of the engine oil circuit 16, it is possible to control the way in which the waste heat is utilized. For example, depending on a position of the bypass valve 34a, the waste heat is conducted to or past the latent heat store 32 in order to keep the engine heat in the engine block. The bypass valve 34b serves for regulating whether the cooling water is conducted through the front-end radiator 22 for cooling purposes or, in this exemplary embodiment, is utilized for charging the latent heat store 32. Finally, the bypass valve 34c serves for setting whether the coolant is conducted directly back to the internal combustion engine 12 during a cold start for the purpose of a faster warm-up of said internal combustion engine or is conducted through the heat exchanger 26 for the purpose of heating the vehicle passenger compartment.

As a result of the arrangement of the latent heat store 32 in the bypass to the front-end radiator 22, a maximum amount of heat can be conducted from the cooling water into the latent heat store 32 without being lost via the front-end radiator 22 to the environment.

In a further embodiment, further thermally loaded components of the drivetrain may be integrated in the cooling water circuit 14. For example, the cooling water circuit 14 may be thermally coupled to an electric drive machine or to a traction battery of the motor vehicle.

When the internal combustion engine 12 is in a shut-down state, the cooling water circuit 14 can be kept in operation in order to transport the heat from the latent heat store 32 to the heat exchanger 26. In this way, the heating of the passenger compartment can be maintained even while the internal combustion engine 12 is in a shut-down state. This is advantageous for example in the case of purely electric driving operation of a hybrid vehicle or in vehicles which are equipped with an automatic start-stop facility.

When the internal combustion engine 12 is re-started, the latent heat store 32 can be charged again with the waste heat from the drivetrain of the motor vehicle.

If the vehicle is parked and thus the internal combustion engine 12 is shut down for a relatively long period of time, the pump 18 of the cooling water circuit 14 and/or the pump 20 of the engine oil circuit 16 continue to be operated at least for such a length of time that the amount of heat required for the next warm-up phase of the internal combustion engine 12 is present in the latent heat store 32. The warm-up phase of the motor vehicle during the next cold start can thus be shortened. This leads to lower fuel consumption and to reduced emissions. Furthermore, driving comfort is increased, because the passenger compartment of the motor vehicle can be warmed up quickly.

In the heat transporting arrangement 10 according to the invention, use may for example be made of a single heat store 32 which constitutes a local interconnection point in terms of heat transfer technology for all heat circuits 14, 16 which flows through the heat store 32. The thermal energy stored in the heat store 32 can be used both for the pre-heating of the internal combustion engine 12 and also for the climate control of the passenger compartment. Thus, the heat transporting arrangement 10 permits highly energy-efficient utilization of the waste heat of the drivetrain. Furthermore, the number of components required for the heat transporting arrangement 10 can be reduced because a unitary system is used for the heating of the engine and for the climate control of the passenger compartment. Furthermore, it is possible for system components close to the store (for example pumps 18, 20, bypass valve 34 and/or fluid lines of the heat circuits 14, 16) to be integrated into the heat transporting arrangement 30. In this way, the assembly outlay for the heat transporting arrangement 10 can be reduced.

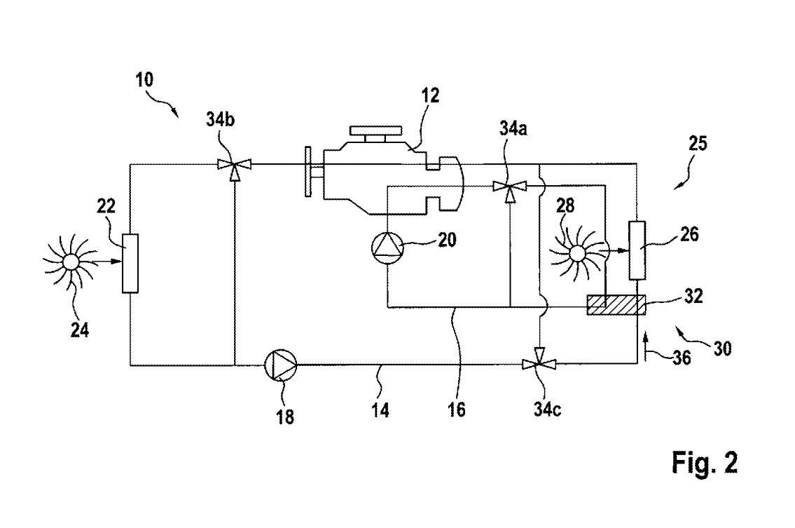

FIGS. 2 to 7 show further embodiments of the heat transporting arrangement 10. The heat transporting arrangements 10 shown in said figures generally correspond in terms of design and mode of operation to the heat transporting arrangement 10 from FIG. 1. Identical elements are therefore denoted by the same reference signs. Substantially the differences will be explained below.

In the heat transporting arrangement 10 illustrated in FIG. 2, the latent heat store 32 is arranged such that the thermal contact with the cooling water circuit 14 is realized at a location a short distance upstream of the point at which the cooling water flows through the heat exchanger 26 (the arrow 36 in FIG. 2 indicates the flow direction of the cooling water). In this way, the heat exchanger 26 can discharge heat, for the purpose of heating the vehicle passenger compartment, in a particularly effective manner because heat losses in the cooling water circuit 14 on the path between the latent heat store 32 and the heat exchanger 26 are substantially eliminated.

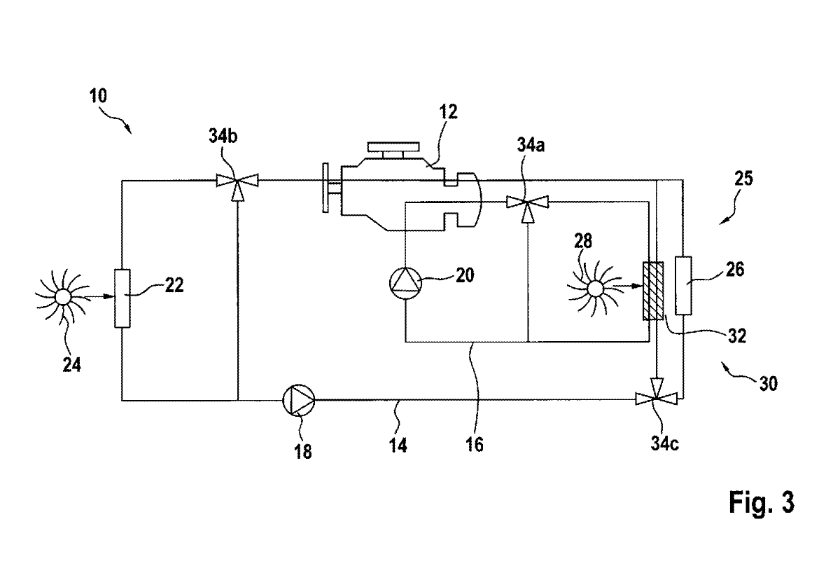

A further advantageous embodiment of the heat transporting arrangement 10 is shown in FIG. 3. Here, the latent heat store 32 is arranged such that the thermal energy is transferred from the latent heat store 32 for the heat exchanger 26 substantially owing to the operation of the heating fan 28. This makes it possible for the vehicle passenger compartment to be heated while the internal combustion engine 12 is in a shut-down state and for the circulation of the cooling water in the cooling water circuit 14 to simultaneously be stopped. Thus, in said situation, the operation of the pump 18 can be stopped, and energy can thus be saved.

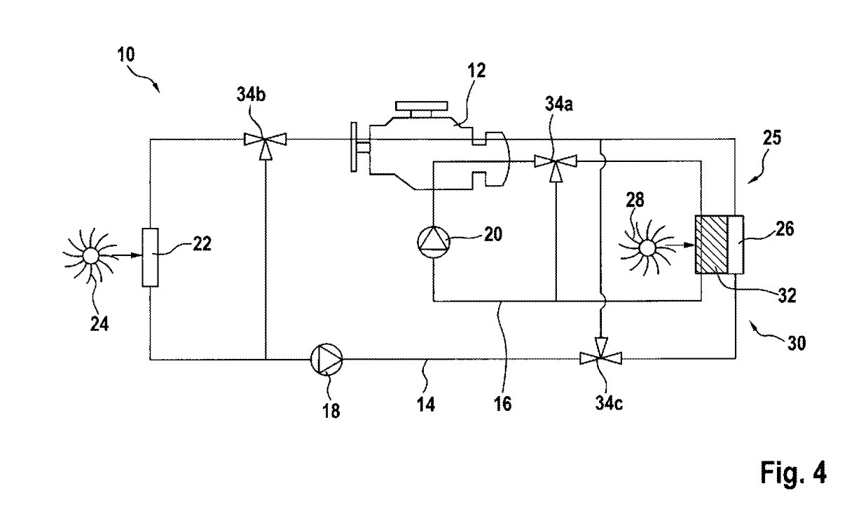

In FIG. 4, the latent heat store 32 is arranged so as to be in direct thermal contact with the heat exchanger 26. As a result, when the heating fan 28 is in operation, the latent heat store 32 can transfer its thermal energy to the heat exchanger 26 without the cooling water circuit 14 having to be active for this purpose. The advantage of the heat transporting arrangement 10 shown in FIG. 4 consists in that only the engine oil circuit 16 flows through the latent heat store 32. This leads to a simpler design of the latent heat store 32 and to a reduction in production costs.

Even though, in this embodiment, only the engine oil circuit 16 flows through the latent heat store 32, it is nevertheless possible for the heat transported in the engine oil circuit 16 and the heat transported in the cooling water circuit 14 to be stored in the latent heat store 32, because the latent heat store 32 is in direct thermal contact with the cooling water circuit 14 via the heat exchanger 26.

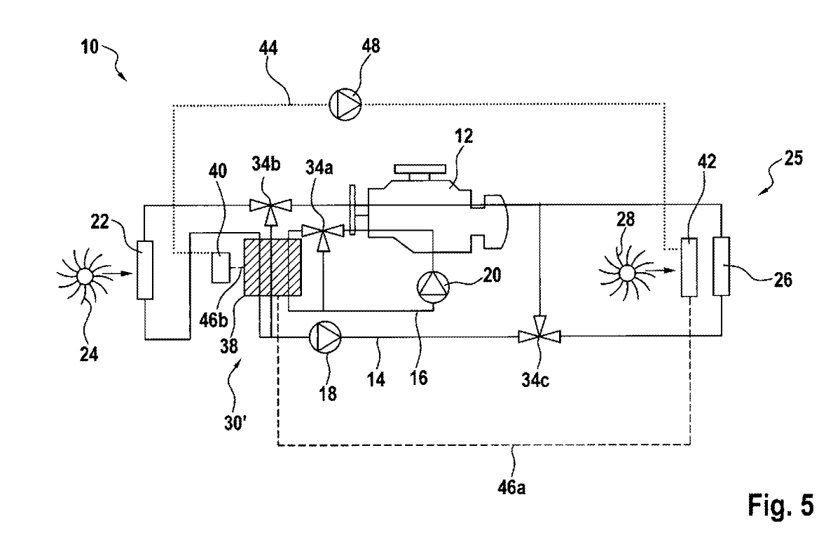

In the heat transporting arrangement 10 illustrated in FIG. 5, the heat store arrangement 30′ has an adsorption store 38 instead of the latent heat store 32. Furthermore, the temperature control device 25 additionally has a condenser 40 and an evaporator 42 which are both coupled to the adsorption store 38. The coupling between the condenser 40, the evaporator 42 and the adsorption store 38 is realized by means of a fluid line 44, in which liquid water is conducted, and a vapor line 46 for conducting water vapor. Into the fluid line 44 there is integrated a dosing pump 48 which sets the flow rate of the transported water.

The release or absorption of energy by the adsorption store 38 is based on an adsorption process or a desorption process respectively. During the adsorption process, the dosing pump 48 pumps water from the condenser 40 to the evaporator 42. In the evaporator 42, the water evaporates to form water vapor, and thus, in conjunction with the heating fan 28, cools the vehicle passenger compartment. The water vapor that is generated is conducted via the vapor line 46a to the adsorption store 38 and is bound in the form of water therein. The release of heat from the cooling water circuit 14 and from the engine oil circuit 16 to the adsorption store 38 is stopped during the adsorption process by means of a corresponding switching position of the bypass valves 34a, 34b. Instead, the cooling water is diverted to the front-end radiator 22. The cooled cooling water from the front-end radiator 22 subsequently passes into the adsorption store 38, and thereby assists the adsorption process.

During the desorption process, that is to say the regeneration of the adsorption store 38, the release of heat to the adsorption store 38 from the cooling water circuit 14 and from the engine oil circuit 16 is reactivated by means of the bypass valves 34a, 34b. By means of the supplied heat, the water bound in the adsorption store 38 is released in the form of water vapor. The water vapor passes via the vapor line 46b to the condenser 40, in which the water vapor condenses to form water.

Through the use of the adsorption store 38 and the temperature control device 25 coupled thereto, it is possible for the vehicle passenger compartment and/or components of the drivetrain (for example a traction battery of a hybrid vehicle) to be cooled. It is self-evident that the heat exchanger 26 may, as described in the preceding exemplary embodiments, be utilized for heating of the vehicle passenger compartment.

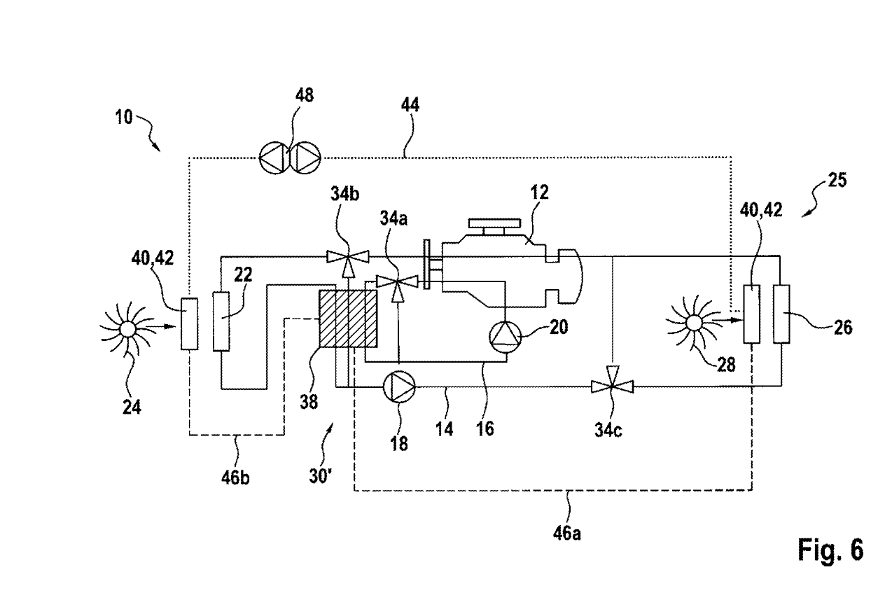

The heat transporting arrangement 10 illustrated in FIG. 6 corresponds substantially to the heat transporting arrangement 10 described in FIG. 5. By contrast to FIG. 5, however, it is possible, depending on the application, for the elements denoted by the reference signs 40, 42 to perform either the function of the condenser 40 or the function of the evaporator 42. Furthermore, the dosing pump 48 is designed such that it can be operated in two flow directions.

If the condenser/evaporator 40, 42 in the vicinity of the front-end radiator 22 is used as a condenser 40 and the condenser/evaporator 40, 42 in the vicinity of the heat exchanger 26 is used as an evaporator 42, then the design and the mode of operation of the heat transporting arrangement 10 corresponds to the embodiment described in FIG. 5.

However, in the event that the vehicle passenger compartment is to be heated and the evaporator/condenser 40, 42 at the heat exchanger is not to be used for condensing moisture out of the air stream to be heated (this is the case if the air to be heated must be dehumidified so as to prevent window fogging), said evaporator/condenser 40, 42 must be deactivated. In order that water vapor can nevertheless be generated for the heat-releasing absorption process, the condenser/evaporator 40, 42 at the front-end radiator is used as an evaporator 42. For this purpose, before the operation thereof, the water contained therein is pumped over, by means of the switchable dosing pump 48 that operates in two directions, into the evaporator/condenser 40, 42 at the heat exchanger, the latter evaporator/condenser thus being used as a condenser 40. For the adsorption process that can subsequently be started, the condenser 40 constitutes the water store from which the dosing pump 48 pumps a defined mass flow of water into the evaporator 42 in order to set the rate of the adsorption process and thus to set the power output thereof. Owing to the operation of the condenser/evaporator 40, 42 at the heat exchanger as a condenser 40, the condensing-out of water during the desorption phase results in additional heat being gained from this process, said additional heat being used to assist the heat exchanger 26 from an energy aspect.

An advantage of the embodiments of FIGS. 5 and 6 is that both heat energy and also cold energy can be conducted into the vehicle passenger compartment, and that furthermore, the provision of the respective thermal energy incurs substantially no operating costs (energy costs) because the waste heat of the drivetrain that is generated during normal operation of the motor vehicle is used by means of the cooling water circuit 14 and the engine oil circuit 16.

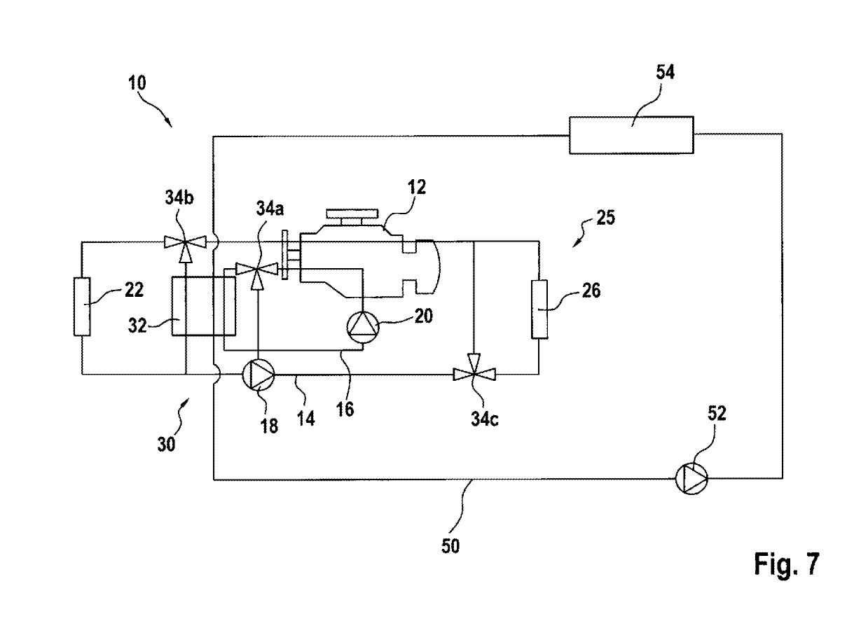

The heat transporting arrangement 10 illustrated in FIG. 7 corresponds substantially to the heat transporting arrangement 10 illustrated in FIG. 1. By contrast to the latter, the present heat transporting arrangement 10 additionally has an exhaust-gas heat circuit 50. In the exhaust-gas heat circuit 50 there is accommodated an exhaust-gas heat transporting medium (for example a liquid coolant) which is circulated in the exhaust-gas heat circuit 50 by a pump 52. The exhaust-gas heat circuit 50 furthermore has an exhaust-gas heat exchanger 54 which is thermally coupled to an exhaust-gas stream of the internal combustion engine 12. It is thus possible for additional heat to be gained from the exhaust-gas stream of the internal combustion engine 12, which additional heat is stored in the latent heat store 32 and can be used for pre-heating of the engine and/or for climate control of the passenger compartment. This permits even more efficient utilization of the waste heat of the drivetrain.

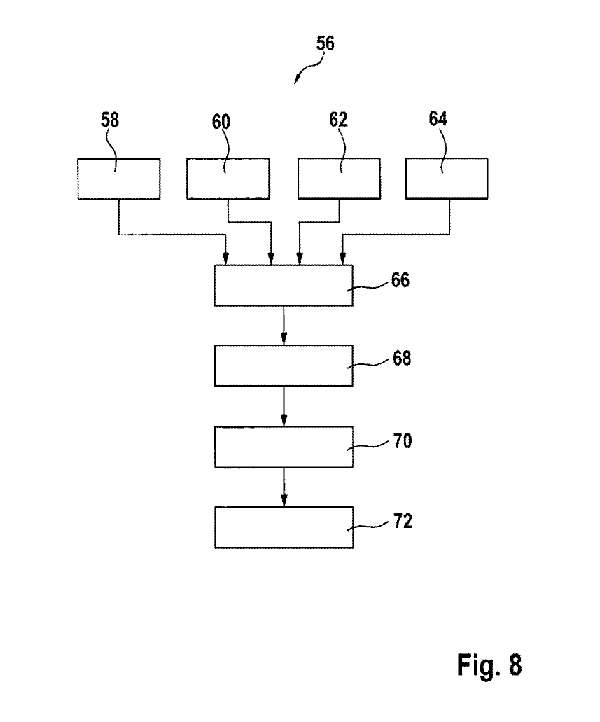

FIG. 8 shows a diagram for the explanation of an embodiment of a method 56 according to the invention. For the explanation of the method 56, it should be assumed by way of example that the motor vehicle is a hybrid vehicle in which initially the internal combustion engine 12 is activated and in which an electric machine is at least intermittently also operated for the purpose of driving the vehicle.

In a step 58, waste heat is dissipated from the internal combustion engine 12 by means of the cooling water circuit 14. In addition, the cooling water circuit 14 is thermally coupled to the traction battery of the hybrid vehicle. Therefore, in a step 60, the excess heat of the fraction battery is dissipated by means of the cooling water circuit 14. Furthermore, in a step 62, the engine oil circuit 16 is used for dissipating heat from the internal combustion engine 12. It should also be assumed that the drivetrain of the motor vehicle has a transmission which can be heated or cooled by means of a transmission oil circuit. For this purpose, the transmission oil circuit is thermally coupled to the transmission. In a step 64, the waste heat of the transmission is dissipated via the transmission oil circuit.

In a step 66, the heat of said heat circuits is stored in the heat transporting arrangement 30.

In a step 68, it should be assumed that the internal combustion engine 12 is in a shut-down state. This may for example be an operating situation in which a vehicle with an automatic start-stop facility is stopped at a red traffic signal, in which a hybrid vehicle is being operated purely electrically, or in which the vehicle is shut down/parked.

In a step 74, the pumps of the various heat circuits then continue to be operated in order that the residual heat of the drivetrain is absorbed in the heat transporting arrangement 30.

In a step 72, the thermal energy stored in the heat transporting arrangement 30 is released, for example for the purpose of pre-heating the internal combustion engine 12 and the transmission and/or for climate control of the passenger compartment.

It is self-evident that the regulation of the heating/cooling and the selection of the components whose temperature is to be controlled are dependent on the respective operating situation of the motor vehicle (for example cold start of the drivetrain, brief stoppage of the drivetrain controlled by the automatic start-stop facility, ambient temperature, etc.).

What is claimed is:

1. A heat transporting arrangement (10) for a motor vehicle, wherein the motor vehicle has a drivetrain with a multiplicity of components and wherein one of the components is an internal combustion engine (12), the arrangement comprising:
at least one heat circuit (14, 16, 50) in which a heat transporting medium is accommodated and which is thermally coupled to one of the components of the drivetrain in order to exchange heat between the component and the heat transporting medium,
a temperature control device (25) which is configured to heat a passenger compartment of the motor vehicle, and
a heat store arrangement (30) which is coupled to the heat circuit (14, 16, 50) and to the temperature control device (25) and which is configured to store heat discharged from the heat transporting medium and to release said heat for the purpose of heating one of the components of the drivetrain and a passenger compartment.

2. The heat transporting arrangement according to claim 1, wherein the temperature control device (25) is configured to cool at least one of a component of the drivetrain and the passenger compartment, and wherein the heat store arrangement (30) is configured to release the stored heat for the purpose of cooling at least one of a component of the drivetrain and the passenger compartment.

3. The heat transporting arrangement according to claim 1, wherein the heat circuit is a cooling water circuit (14) in which cooling water is accommodated as a heat transporting medium and which is thermally coupled to the internal combustion engine (12) in order to heat or cool the internal combustion engine (12) by means of the cooling water.

4. The heat transporting arrangement according to claim 3, wherein the temperature control device (25) has a heat exchanger (26) which is thermally coupled to the cooling water circuit (14) and which is configured to transfer heat from the heat transporting medium into the passenger compartment of the motor vehicle.

5. The heat transporting arrangement according to claim 1, wherein the heat circuit is an engine oil circuit (16) in which engine oil is accommodated as a heat transporting medium and which is thermally coupled to the internal combustion engine (12) in order to heat or cool the internal combustion engine (12) by means of the engine oil.

6. The heat transporting arrangement according to claim 1, wherein one of the components of the drivetrain is a transmission, and wherein the heat circuit is a transmission oil circuit in which transmission oil is accommodated as a heat transporting medium and which is thermally coupled to the transmission in order to heat or cool the transmission by means of the transmission oil.

7. The heat transporting arrangement according to claim 1, wherein the heat circuit is an exhaust-gas heat circuit (50) in which an exhaust-gas heat transporting medium is accommodated as a heat transporting medium and which is thermally coupled via an exhaust-gas heat exchanger (54) to an exhaust-gas stream of the internal combustion engine (12) in order to transfer heat of the exhaust-gas stream to the exhaust-gas heat transporting medium.

8. The heat transporting arrangement according to claim 1, wherein the heat transporting arrangement (10) has a multiplicity of heat circuits (14, 16, 50) which are in each case thermally coupled to one of the components of the drivetrain, and wherein the heat store arrangement (30) is thermally coupled to each of the heat circuits (14, 16, 50).

9. The heat transporting arrangement according to claim 8, wherein one of the heat circuits is a cooling water circuit (14) and another of the heat circuits is an engine oil circuit (16).

10. The heat transporting arrangement according to claim 1, wherein the heat store arrangement (30) has a latent heat store (32).

11. The heat transporting arrangement according to claim 1, wherein the heat store arrangement (30) has an adsorption store (38) and the temperature control device (25) has a condenser (40) and an evaporator (42), wherein the condenser (40) is configured to condense adsorbate released during a desorption phase of the adsorption store (38), and wherein the evaporator (42) is configured to evaporate condensed adsorbate, to cool a medium surrounding the evaporator (42) and to supply the adsorbate to the adsorption store (38) during an adsorption phase of the adsorption store (38).

12. A method (56) for the exchange of heat in a motor vehicle by means of a heat transporting arrangement (10), wherein the motor vehicle has a drivetrain with a multiplicity of components, wherein one of the components is an internal combustion engine (12), wherein the heat transporting arrangement (10) has at least one heat circuit (14, 16, 50), which is thermally coupled to one of the components of the drivetrain, a temperature control device (25) and a heat store arrangement (30) which is coupled to the heat circuit (14, 16, 50) and to the temperature control device (25), the method comprising the steps:
discharging heat from one of the components of the drivetrain by means of the heat circuit (14, 16, 50),
storing the heat from the heat circuit (14, 16, 50) in the heat store arrangement (30), and
releasing the stored heat from the heat store arrangement (30) to the heat circuit (14, 16, 50) in order to heat one of the components of the drivetrain and a passenger compartment of the motor vehicle.

13. The method according to claim 12, wherein stored heat is released from the heat store arrangement (30) in order to cool at least one of a component of the drivetrain and the passenger compartment.

14. The method according to claim 12, wherein at least a part of the heat is discharged and stored while the internal combustion engine (12) is in a shut-down state.

15. The method according to claim 12, wherein at least a part of the stored heat is released while the internal combustion engine (12) is in a shut-down state.
